(19) United States
(12) Patent Application Publication
(10) Pub. No.: US 2008/0001717 A1
(43) Pub. Date: Jan. 3, 2008

(54) System and method for group management

(76) Inventor: Trevor Fiatal, Fremont, CA (US)

Correspondence Address: CARR & FERRELL LLP, 2200 GENG ROAD, PALO ALTO, CA, 94303, US

(21) Appl. No.: 11/729,314

(22) Filed: Mar. 27, 2007

Related U.S. Application Data
(63) Continuation-in-part of application No. 11/701,590, filed on Feb. 2, 2007.
(60) Provisional application No. 60/805,301, filed on Jun. 20, 2006.

(51) Int. Cl. H04Q 3/06

(52) U.S. Cl. 340/10.3

(57) ABSTRACT

Systems and methods for managing groups and group communications are provided. Groups of one or more individuals may be indicated by tags, which are associated with each individual in the group. Subsequent operations involving a tag may be associated with each individual in the group. Further, various kinds of information, such as messages, involving individuals in a group may be retrieved based on a search for the tag.

### CROSS-REFERENCE TO RELATED APPLICATIONS

The present application is a continuation-in-part of U.S. patent application Ser. No. 11/701,590 filed Feb. 2, 2007 and entitled “Systems and Methods for Group Messaging,” which claims the priority benefit of U.S. provisional patent application No. 60/805,301 filed Jun. 20, 2006 and entitled “Communication And Content Sharing Across Social Networks.”

The present application is related to co-pending U.S. patent application Ser. No. 11/363,912 filed Feb. 27, 2006, entitled “Context Based Action.” The disclosures of all of the aforementioned applications are incorporated herein by reference.

### BACKGROUND OF THE INVENTION

1. Field of the Invention

The present invention relates to information and communication management. More specifically, the present invention relates to the management of groups and group communications in the context of communication devices such as cellular telephones, smart phones, personal data assistants (PDAs), wireless electronic mail devices, and the like.

2. Description of Related Art

Communication devices generally include a contacts database to store information concerning any and all individuals known to the user. A contacts database may include various types of information concerning each individual, including each individual's name, title, place of work, contact information, including addresses, phone numbers, e-mail addresses, websites, and the like. Some individuals may be associated with the user and with each other in various ways, such as, for example, work colleagues or soccer teammates. Further, some of these associations or groups may overlap. For example, a work colleague of the user's may also be a soccer teammate.

Further, contact information for each individual may include a variety of communication media, including short message service (SMS) text messaging, instant messaging (IM), and/or electronic mail (e-mail). In some instances, an individual may utilize multiple SMS messaging services, IM services, and/or e-mail providers. The variety of available communication media in conjunction with multiple service offerings thereof offers the advantage of options and alternatives should any of the one or more of the media fail to provide prompt access to the individual. The information concerning the various communication media, as well as the information concerning each individual's group affiliation, is saved in the contacts database. Notwithstanding, such a comprehensive database complicates the process of managing and retrieving information.

Some communication media presently allow for group messaging whereby an individual may send a message to a group of contacts. For example, e-mail services allow a user to send a message to a group of contacts by entering the name of each individual contact in a newly defined group or the individual contact may be added to a previously defined group or list of contacts. A list may be as simple as “everyone,” which includes every individual contact in the user's contacts database. Alternatively, the user may make custom lists for various groups of contacts, such as “family” for family members, “work” for work-related contacts, “soccer team” for soccer teammates, and “book club” for members of a book club. When an e-mail is addressed and sent to a particular group, that e-mail is automatically sent to each member of the group at that member's respective e-mail address.

Other communication media presently lack the functionality for group messaging. For example, SMS text messaging cannot be used to send a message to a group. SMS text messaging can generally only send a short text message from one device to one other device. If a user wishes to send an SMS text message to a group, the user must retype and separately send the message to each individual in the group.

While the ability to communicate with various groups of individuals using a variety of communications media allows for convenience and expediency in reaching each individual, managing all the communications to and from all those individuals becomes complicated. For example, a user may wish to retrieve a message concerning a work project from among various messages sent and received from various work colleagues through e-mail, IM, and/or SMS. Presently, the only way to retrieve the message is by searching the mailboxes of each communication media separately. There is, therefore, a need in the art for improved systems and methods for managing groups and group communications.

### SUMMARY OF THE INVENTION

Exemplary systems and methods of the present invention provide for managing groups and group communications. In various embodiments of the present invention, information concerning a tag and concerning a group of one or more individuals in a contacts database. Tags may be used shorthand indicators for a group of individuals. The tag is associated with each member of the group, and subsequent communications using a tag may be automatically sent to each group member. In various embodiments of the present invention, the tagged communication may be sent to each group member using a preferred communication medium.

Various embodiments of the present invention allow for the retrieval of information (e.g., messages sent to and received from) concerning an individual based on a search for any of the tags associated with that individual. In an exemplary embodiment, a user may create a “family” tag and designate a father, mother, and sister to be associated with the tag. Subsequently, communications using the “family” tag may be automatically sent to the user's father, mother, and sister. Further, if the user wishes to find a communication sent to or received from a family member, the user may simply do a search for the “family” tag.

Various embodiments of the present invention include systems for managing groups and group communications, which may include input/output, contacts database, a processor, and a tagging module. An exemplary implementation may include a user inputting a new tag and designating a group of individuals in the contacts database. The tagging module associates the tag with the group of individuals, so that subsequent communications that get tagged may be automatically sent to each group member.

Some embodiments of the present invention include computer media and instructions for managing groups and group communication by using tags associated with certain groups. The association between a tag and a group may be used to search and retrieve various information concerning the group or individual group members.

### BRIEF DESCRIPTION OF FIGURES

FIG. 1 is an illustration of a mobile device that may be used in a system for managing groups and group communications, in accordance with an exemplary embodiment of the present invention.

FIG. 2A is an illustration of a contacts database that may be used in a system for managing groups and group communications, in accordance with an exemplary embodiment of the present invention.

FIG. 2B is an illustration of a contacts database sorted by contact, in accordance with an exemplary embodiment of the present invention.

FIG. 2C is an illustration of a contacts database sorted by tag, in accordance with an exemplary embodiment of the present invention.

FIG. 3 is a flowchart depicting a method for managing groups and group communications, in accordance with an exemplary embodiment of the present invention.

### DETAILED DESCRIPTION

The present invention includes systems and methods for managing groups and group communications. A group of one or more individuals is associated with a tag, and operations involving any group member would also be tagged. The association between the tag and the group allows for information retrieval based on a search either for the tag or for any of the group members. In various embodiments of the present invention, the information may include messages sent from and/or sent to each individual in the group.

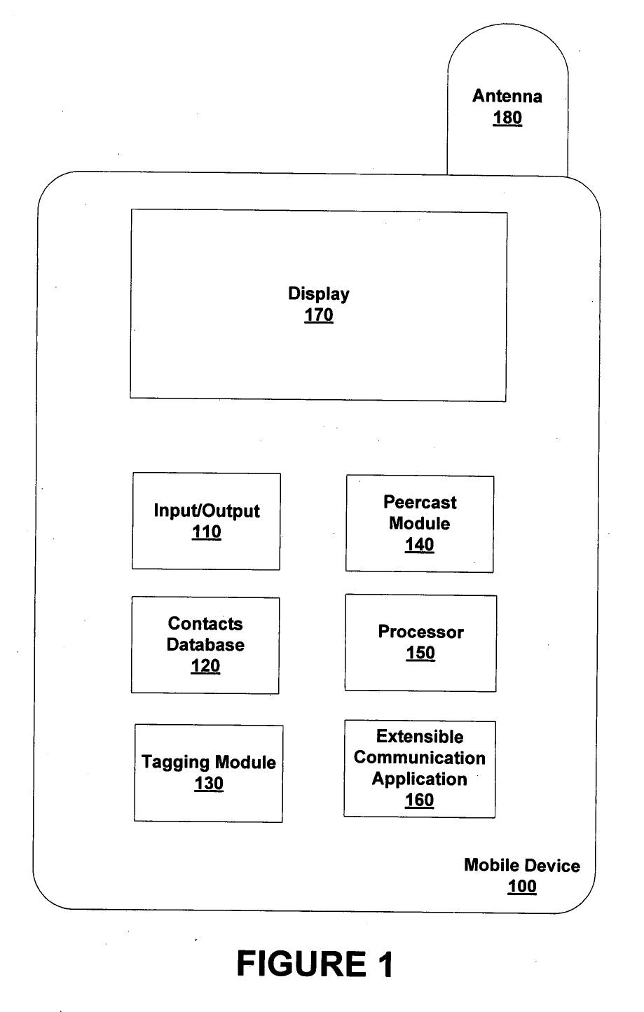

FIG. 1 is an illustration of an exemplary mobile device 100 that may be used in a system for managing groups and group communications, according to various embodiments of the present invention. Mobile device 100 may include cellular telephones, smart phones, PDAs, wireless e-mail devices, handheld computers, and the like. In some embodiments of the present invention, mobile device 100 may comprise input/output component(s) 110, a contacts database 120, a tagging module 130, a peercast module 140, a processor 150, an extensible communication application 160, a display 170, and an antenna 180.

Input/output 110 may include any of a variety of hardware and/or software components configured to allow for communication between the user, other components of mobile device 100, and, in conjunction with antenna 180, other mobile devices. The communications may include audio/visual information, SMS text messages, IMs, and e-mail messages. Input/output 110 may include a keypad, keyboard, touchpad, touch screen, speech recognition applications, microphone, speakers, and the like. Some embodiments of the present invention may include one or more input/output 110 components operating individually or in combination with one another.

Contacts database 120 may be a database configured to store information regarding various contacts. Such contact information may include information concerning various communication media associated with each contact, including e-mail addresses, IM addresses, and SMS numbers/addresses. Information may be added, deleted, and edited in contacts database 120 using one or more input/output 110 components. For example, a keypad may be used to enter a new telephone number. Other examples may include automatic add options offered upon receipt of a phone call or message and synching operations performed by cable or wirelessly.

Personal preferences may be included in contacts database 120 in association with each personal contact entry. For example, a person may have a preference about which e-mail/IM addresses to use. That person may be more likely to check that particular e-mail/IM address more frequently than other communication media. Thus, using the preferred address may allow a person to receive messages more quickly than messages sent to another address via another medium. Further, a person may have different preferences based on the context of the message, which may be related to a group affiliation. For example, a person may prefer to receive work-related messages through e-mail and to receive soccer team-related messages through text messages.

Contacts database 120 may further include information concerning the various groups to which a contact belongs. Group affiliation may be indicated by tags. A tag, created and managed by tagging module 130, may be used by the user as a shorthand indicator for all the individuals in the group. The tag may be stored in contacts database 120 and processed by, for example, processor 150 alone or in conjunction with other components and modules of mobile device 100.

A module (or application), as referenced in the present invention, is a collection of routines that perform various system-level functions and may be dynamically loaded and unloaded by hardware and device drivers as required. The modular software components described herein may also be incorporated as part of a larger software platform or integrated as part of an application specific component.

Operating either independently or in conjunction with contacts database 120, tagging module 130 is configured to create and manage the various tags included in contacts database 120. Creating a tag using tagging module 130 may include receiving user input concerning the name of the tag and user input identifying one or more individuals in the contacts database 120 to be associated with the tag. Tag creation may also occur implicitly. For example, a user may wish to have a tag for frequently e-mailed groups. A user may also have implicitly created tags for frequently IM-ed groups, frequently SMS text messaged groups, and the like.

Tags may also be imported from other sources, including other databases and incoming messages. For example, a user may wish to sync contacts database 120 with her e-mail address book. Any tags that existed in the e-mail address book may be imported into contacts database 120, along with the contacts with which the tags are associated. Further, an implicit tag indicating the specific data source (e.g., “Contacts from user@email.com”) may be created and associated with the imported contacts. Using tagging module 130, a user may edit any tag, which may include changing the tag name, changing the membership of the group with which the tag is associated, and the like.

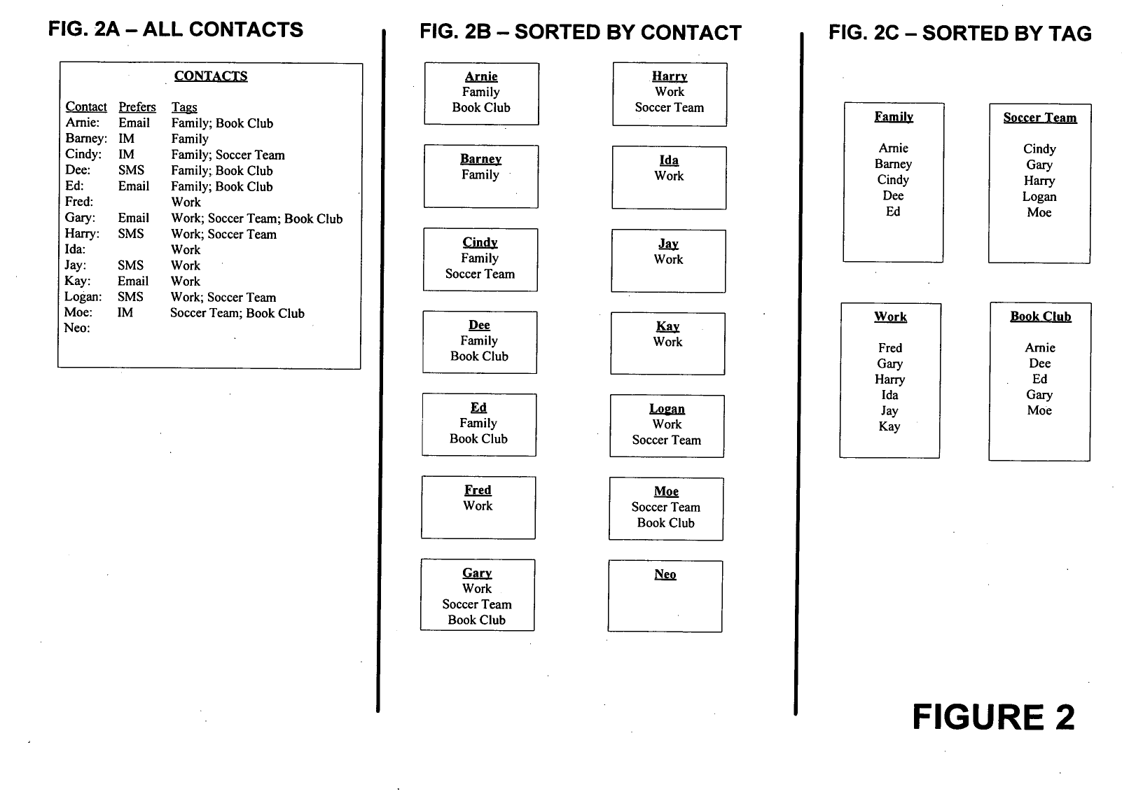

Tagging module 130 allows for the user to associate an individual with no tag, one tag, or a plurality of tags. Tagging module 130 may allow the user to sort the contacts database 120 by contact and/or by tag, as can be seen in FIG. 2. For example, a user may wish to send a message to all of the user's family members. Rather than individually looking up and/or typing out each family member's contact information, the user may simply address the message using the tag “Family.”

An optional peercast module 140 is configured to allow a user to send a message to a group of contacts using each contact's preferred communication medium. User input concerning content or recipient of a message may be received by peercast module 140 from input/output 110. Peercast module 140 may operate in conjunction with contacts database 120 and tagging module 130 to allow the user to address the message to a group using a tag. After the message is addressed using a tag, peercast module 140 sends the message to each individual in the group using that individual's preferred communication medium by operating in conjunction with extensible communications application 160 as detailed below.

Processor 150 is configured to execute a variety of operations. These operations include taking into account various kinds of information, such as associations between tags and individuals, in retrieving information. The information retrieved may be contact information, communication information, or the like. For example, a user may wish to search contacts database 120 for an individual who is a member of the user's family. The user may use input/output 110 to indicate that the user wishes to find individuals associated with the “family” tag. Processor 150 may evaluate the search criterion and in conjunction with tagging module 130, retrieve a list of contacts from contacts database 120 that are associated with the “family” tag. The user may then choose to view the contact information of the individual family member. In another example, the user may wish to retrieve a specific message concerning a family matter. By basing the search on the tag “family”, processor 150 is able to retrieve all messages sent to and/or received from all individuals in the “family” group. Processor 150 may use any of a variety of other factors, independently or in conjunction with each other, to retrieve information.

In some embodiments of the present invention, processor 150 is further configured to evaluate such factors as preferences, presence, and/or location, in determining a communication medium for reaching each individual. Processor 150 may determine a medium of communication based on factors such as predetermined personal preference, which may be indicated by, for example, user input into contacts database 120. Alternatively, processor 150 may determine an effective medium of communication based on presence, which may be indicated when an individual turns on his/her mobile device, logs in, signs in, or the like, in order to access a message. Such presence information may be received by mobile device 110 in a fashion like that described in U.S. patent application Ser. No. 11/363,912 and provided to processor 150, which may then use presence as a factor in determining which communication medium to use. As disclosed in U.S. patent application Ser. No. 11/607,620 titled “Location-Based Operations and Messaging,” filed Dec. 1, 2006 (the disclosure of which is incorporated by reference), processor 150 may also use the individual's location as may be determined by GPS and/or A-GPS, to determine the communication medium most likely to be successful at contacting the individual. Processor 150 may use any of a variety of factors, independently or in conjunction with each other, to determine the most effective medium of communication for reaching the contact.

Extensible communication application 160 allows for the use of a single mobile device 100 in efficiently managing multiple communication media (IM, SMS, e-mail, etc.). Allowing for integration and cross-platform interoperability, extensible communication application 160 further allows a user of mobile device 100 to access various communications media in a cumulative, integrated setting so that a user does not have to log repeatedly into each individual service to be able to send and/or receive messages. Various embodiments of extensible communication application 160 allow for authentication and secure transmission for each communication medium. In various embodiments of the present invention, extensible communication application 160 further integrates various address books, contact lists such as those in contacts database 120, calendars, and the like. In an embodiment of the present invention, extensible communications application 160 may operate in conjunction with peercast module 140 and processor 150 to allow for delivery of messages to users utilizing a preferred communication medium.

Extensible communication application 160 may include any of a variety of software applications configured to integrate the variety of protocols and/or applications required to access various communications media via mobile device 100. Such protocols may include Internet Message Access Protocol (IMAP), Instant Message and Presence Service (IMPS), Session Initiation Protocol for Instant Messaging and Presence Leveraging Extensions (SIP/SIMPLE), Post Office Protocol 3 (POP3), Simple Mail Transfer Protocol (SMTP), Hypertext Transfer Protocol (HTTP), SMS, Internet Protocol (IP), Session Initiation Protocol (SIP) and the like.

Extensible software application 160 may be similar to that described in U.S. provisional patent application Ser. No. 60/805,301, which has previously been incorporated herein by reference. In some embodiments of the present invention, an extensible communications application 160 or other application offering similar functionality and that may assist in making communication media determinations may reside at a communication management server, as described in U.S. patent application Ser. No. 11/363,912, which has previously been incorporated herein by reference.

A variety of communication applications may be accessible and integrated with extensible communication application 160. For example, an individual may have multiple e-mail addresses, such as Yahoo®, Gmail®, Microsoft® Outlook, and the like. An individual may have multiple IM addresses, such as Yahoo® IM, America Online® (AOL) IM, Google Talk (GTalk™), ICQ, and the like. Further, incorporating an application, such as Jabber® may enable increased interoperability with IM applications such as AOL/AIM, Yahoo® IM, GTalk™, and various other communications protocols. Extensible communications application 160 may further operate in conjunction with input/output component 110.

By operating in conjunction with peercast module 140 and extensible communication application 160, display 170 may be configured to display a user environment through which various communications applications can be conveniently accessed and used to send messages. Display 170 may also operate in conjunction with contacts database 120 to display information for a contact. For example, when a user searches for a contact, the information concerning that contact's group affiliations and various communication media may be displayed by display 170. Display 170 may further reflect indications concerning the current presence, activity, and/or log-in status of the contact through each communication medium.

Antenna 180 may be configured to receive and transmit various electromagnetic waves, including, for example, radio signals. Various embodiments may include external antennas, internal antennas, wireless network antennas, and the like. The electromagnetic waves received and transmitted by antenna 180 may convey various kinds of information, including the communication information generated or received by input/output components 110.

FIG. 2A is an illustration of an exemplary contacts database 120 that may be used in a system for groups and group communications, according to various embodiments of the present invention. Contacts database 120 and tagging module 130 may operate in conjunction to allow for the creation and management of the various groups significant to the user. For example, FIG. 2A illustrates an exemplary contacts database including information about various individuals. Such information may include communication media preferences and affiliation to groups such as family, work colleagues, soccer teammates, book club members, and others. Further, there may be overlap among the groups. For example, a family member may also be a soccer teammate, and a work colleague may also be a fellow book club member.

FIG. 2B is an illustration of an exemplary contacts database 120 sorted by contact, according to various embodiments of the present invention. The user may desire to view and/or search the contacts database 120 by contact. For example, a user may wish to send a message to an individual contact. Viewing that contact's group affiliations may allow the user to include, in the message, information concerning the various groups. Further, sorting by contact may facilitate the user's ability to view and edit an individual's group affiliations (i.e., adding or removing the individual from various groups).

FIG. 2C is an illustration of an exemplary contacts database 120 sorted by tag, according to various embodiments of the present invention. When a user wishes to send a message to a group, the user may search contacts database 120 for the tag associated with that group. For example, if the user is sending a message to family members, the user may search for that group's tag, which may appear as “family” or be customized by user to appear as “Smith Family,” “The Brethren,” “My Clan,” or the like. Sorting by tag may further help a user to edit the membership of the various groups associated with the tag.

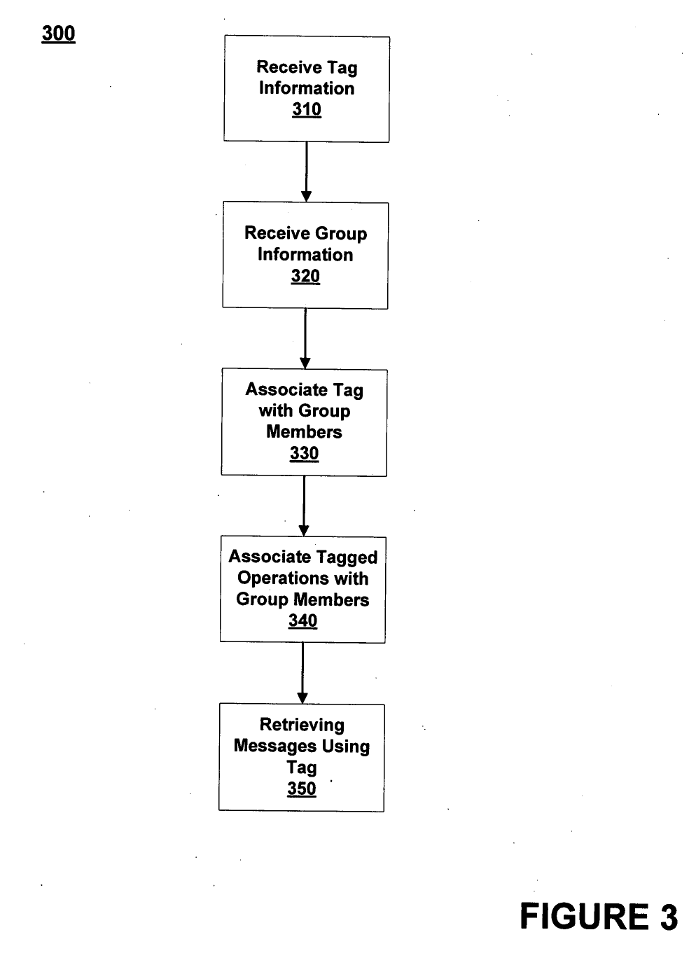

FIG. 3 is a flowchart depicting an exemplary method for group and group communication management 300, according to various embodiments of the present invention. In this exemplary method 300, input concerning a tag and a group is received, an association between the tag and group is created, and operations involving the tag are associated with each member of the group.

In step 310, a user inputs tag information into mobile device 100 using input/output component 110. The information will be stored in contacts database 120. Inputting tag information may include creating a new tag, editing an existing tag, importing a tag, and the like by using tagging module 130. Importing a tag may occur when a user transfers data from another database, syncs information on mobile device 100 with another device, or the like. Further, tag information may be implicitly defined through derivation from other information received by mobile device 100. For example, tags may be defined from frequently used groups. Specifically, a user may send e-mails frequently to soccer teammates. In some embodiments of the present invention, the user may not explicitly create a tag, as the tag for those group members has been implicitly defined through frequent use. Tags may also be implicitly defined based on usage information available on mobile device 100.

In step 320, the user inputs information concerning a group of one or more individuals. The information will be stored in contacts database 120. Inputting information concerning the group members may include inputting information on each individual separately, searching for individuals in contacts database 120, speaking into a speech recognition component, selecting individuals from contacts database 120, selecting from messages, and/or a combination thereof. Further, the user may search for an existing tag, view a list of individuals associated with that tag, and select individuals from that list.

In step 330, the tag is associated with each member of the group. The association between the tag and group is created and managed by tagging module 130. The user may also use tagging module 130 to create, edit, and manage these associations between tags and groups of individuals. In various embodiments of the present invention, an individual may be associated with no tags, one tag, or a plurality of tags. For example, an individual may be a family member and a soccer teammate, so that individual would be associated with both the “family” and “soccer team” tags.

In step 340, operations using tags are associated with each member of the group. By associating the group with the tag, it becomes possible to expedite various operations involving groups and group communications. For example, messages may be addressed using a tag and sent out to each member of the group without having to enter each recipient name or resend messages individually. More specifically, a user who wishes to send a message to the user's book club may simply address the message using the “book club” tag. That message is automatically sent to each member of the book club. In some embodiments of the present invention, that message is sent to each book club member using a preferred or optimal communication medium.

The association between tags and groups may also allow for more efficient searches and message organization and retrieval. In step 350, the user may choose to retrieve a message by using a tag. For example, a user may wish to retrieve information concerning a work project from communications with various colleagues through multiple e-mails, IMs, and SMS text messages. To avoid having to weed through various other messages, the user may simply do a search for the “Work” tag.

While the present invention has been described in connection with a series of preferred embodiment, these descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art.

What is claimed is:

1. A method for managing groups comprising:
receiving information concerning a tag;
receiving information concerning one or more individuals in a contacts database; and
associating the tag with the one or more individuals in the contacts database, wherein subsequent operations involving the tag are associated with the one or more individuals.

2. The method of claim 1, wherein receiving information concerning a tag comprises creating a tag based on user input.

3. The method of claim 1, wherein receiving information concerning a tag comprises importing information concerning the tag from a source.

4. The method of claim 3, wherein importing information concerning the tag comprises inheriting categories from the source.

5. The method of claim 3, wherein importing information concerning the tag comprises synching information concerning the tag with the source.

6. The method of claim 3, wherein the source is another contacts database.

7. The method of claim 3, wherein the source is an e-mail box.

8. The method of claim 3, wherein the source is an instant messaging group.

9. The method of claim 1, wherein receiving information concerning a tag comprises creating the tag based on usage categories.

10. The method of claim 1, wherein the one or more individuals are designated by a user.

11. The method of claim 1, wherein receiving information concerning one or more individuals comprises importing the information from a source.

12. The method of claim 11, wherein importing the information concerning the one or more individuals comprises inheriting categories from the source.

13. The method of claim 11, wherein importing information concerning the one or more individuals comprises synching information concerning the one or more individuals with the source.

14. The method of claim 11, wherein the source is another contacts database.

15. The method of claim 11, wherein the source is an e-mail box.

16. The method of claim 11, wherein the source is an instant messaging group.

17. The method of claim 11, wherein the source is a tagged message received from another user.

18. The method of claim 1, wherein receiving information concerning the one or more individuals comprises designating the one or more individuals based on usage categories.

19. The method of claim 1, further comprising associating the tag with a preferred communication medium for each of the one or more individuals.

20. The method of claim 20, further comprising sending tagged messages to the one or more individuals using the preferred communication medium of each of the one or more individuals associated with the tag.

21. The method of claim 1, further comprising retrieving information based on at least the association between the tag and any of the one or more individuals.

22. The method of claim 21, wherein the information comprises messages sent by or sent to any of the one or more individuals.

23. A system for managing groups comprising:
an input/output configured to receive information concerning a tag and one or more individuals;
a contacts database configured to store the information concerning the tag and the one or more individuals;
a tagging module configured to associate the tag with the one or more individuals in the contacts database, wherein subsequent operations involving the tag are associated with the one or more individuals.

24. The system of claim 23, further comprising a processor configured to retrieve information based on at least the association between the tag and any of the one or more individuals.

25. The system of claim 23, wherein the information comprises messages sent by or sent to the one or more individuals.

26. The system of claim 23, further comprising a messaging module configured to send tagged messages to each of the one or more individuals.

27. A computer-readable storage medium having embodied thereon a program, the program being executable by a computer processor to perform a method for managing groups comprising:
receiving information concerning a tag;
receiving information concerning one or more individuals in a contacts database; and
associating the tag with the one or more individuals in the contacts database,
wherein subsequent operations involving the tag are associated with the one or more individuals.

28. The computer-readable storage medium of claim 27, wherein the program further comprises executable instructions to retrieve information based on at least the association between the tag and any of the one or more individuals.

29. The computer-readable storage medium of claim 27, wherein the information comprises messages sent by or sent to the one or more individuals.
